(19) United States
(12) Patent Application Publication
(10) Pub. No.: US 2024/0419281 A1
(43) Pub. Date: Dec. 19, 2024

(54) TOUCH POSITIONING METHOD AND DEVICE, STORAGE MEDIUM AND TOUCH APPARATUS

(71) Applicant: Beijing Taifang Technology Co., Ltd., Beijing (CN)

(72) Inventors: Chaoliang DU, Beijing (CN); Hongfeng GUO, Beijing (CN); Jiaojiao TAO, Beijing (CN); Xiong LEI, Beijing (CN)

(21) Appl. No.: 18/744,770

(22) Filed: Jun. 17, 2024

(30) Foreign Application Priority Data
Jun. 15, 2023 (CN) 202310710958.9
Apr. 15, 2024 (CN) 202410452344.X

(51) Int. Cl. G06F 3/041

(52) U.S. Cl. CPC G06F 3/04166

(57) ABSTRACT

A touch positioning method, a touch positioning device, a storage medium and a touch apparatus are disclosed, wherein the method includes: acquiring a touch signal collected by a touch sensor disposed on the touch apparatus and generated after the touch apparatus is touched; determining a positioning region based on the touch signal collected by the touch sensor, and determining a touch position based on a calibration signal of the touch sensor corresponding to a preset position point in the positioning region; controlling the touch apparatus to execute a corresponding function based on the touch position.

### CROSS-REFERENCE TO RELATED APPLICATIONS

The present application claims priority of Chinese Patent Application No. 202310710958.9, filed to the CNIPA on Jun. 15, 2023 and priority of Chinese Patent Application No. 202410452344X, filed to the CNIPA on Apr. 15, 2024, the contents of which should be regarded as being incorporated herein by reference.

### TECHNICAL FIELD

Embodiments of the present disclosure relate to, but are not limited to, touch technologies, in particular to a touch positioning method, a touch positioning device, a storage medium, and a touch apparatus.

### BACKGROUND

Symmetrical structures are common structures for consumer electronics products, such as square and circular shapes, and sensors are often arranged symmetrically in consumer electronic products, as shown in FIGS. 1 and 2, wherein FIG. 1 is a schematic diagram of a symmetrical arrangement of four sensors, and FIG. 2 is a schematic diagram of a symmetrical arrangement of six sensors.

Due to the symmetrical arrangement of the sensors, symmetrical positions will appear when positioning according to signals of the sensors, which makes it difficult to accurately locate a touch position and affects the positioning accuracy.

### SUMMARY

The following is a summary of the subject matters described in detail in this document. This summary is not intended to limit the scope of protection of the claims.

The present disclosure provides a touch positioning method, the method comprising:
acquiring touch signals collected by sensors disposed on a touch apparatus and generated after the touch apparatus is touched;
determining a positioning region according to the touch signals collected by the sensors, and determining a touch position according to calibration signals of sensors corresponding to a preset position point in the positioning region; and
controlling the touch apparatus to execute a corresponding function based on the touch position.

The present disclosure provides a non-transient computer-readable storage medium, storing program instructions capable of implementing the touch positioning method as described above when the program instructions are executed.

The present disclosure provides a touch positioning device comprising a processor and a memory storing a computer program runnable on the processor, wherein the processor implements the touch positioning method as described above when executing the program.

The present disclosure provides a touch apparatus, comprising:
sensors; and
the touch positioning device as described above, configured to receive touch signals collected by the sensors.

The technical solutions recorded in the present disclosure uses touch signals which are generated after the touch apparatus is touched and collected by sensors and calibration signals of the sensors corresponding to preset touch position points to perform touch positioning, which is equivalent to limiting a positioning range in a positioning process, which improves a positioning accuracy

Other aspects may be understood upon reading and understanding the drawings and detailed description.

### BRIEF DESCRIPTION OF THE DRAWINGS

FIG. 1 is a schematic diagram of a symmetrical arrangement of four sensors according to the present disclosure.

FIG. 2 is a schematic diagram of a symmetrical arrangement of six sensors according to the present disclosure.

FIG. 3 is a flowchart of a touch positioning method according to an embodiment of the present disclosure.

FIG. 4 is a flowchart of another touch positioning method according to an embodiment of the present disclosure.

FIG. 5 is a schematic diagram of signal distribution of four sensors arranged symmetrically according to an embodiment of the present disclosure.

FIG. 6 is a schematic diagram of signal distribution region of four sensors arranged symmetrically according to an embodiment of the present disclosure.

FIG. 7 is a schematic diagram of first-category position points according to an embodiment of the present disclosure.

FIG. 8 is another schematic diagram of first-category position points according to an embodiment of the present disclosure.

FIG. 9 is a schematic diagram of an initial position point and an initial positioning region according to an embodiment of the present disclosure.

FIG. 10 is a diagram of a mapping relationship model between a position point in an initial positioning region and a composite index value for the position point according to an embodiment of the present disclosure.

FIG. 11 is a diagram of another mapping relationship model between a position point in an initial positioning region and a composite index value for the position point according to an embodiment of the present disclosure.

FIG. 12 is a schematic diagram of touch signals collected by a plurality of sensors according to the present disclosure.

FIG. 13 is a flowchart of a method for acquiring touch signals collected by a plurality of sensors according to an embodiment of the present disclosure.

FIG. 14 is a flowchart of a processing method for a multi-channel touch signal according to an embodiment of the present disclosure.

FIG. 15 a diagram of component modules of a touch positioning device according to an embodiment of the present disclosure.

### DETAILED DESCRIPTION

Those of ordinary skills in the art should understand that modifications or equivalent replacements may be made to the technical solutions of embodiments of the present disclosure without departing from the essence and scope of the technical solutions of the present disclosure, and shall all fall within the scope of the claims of the present disclosure.

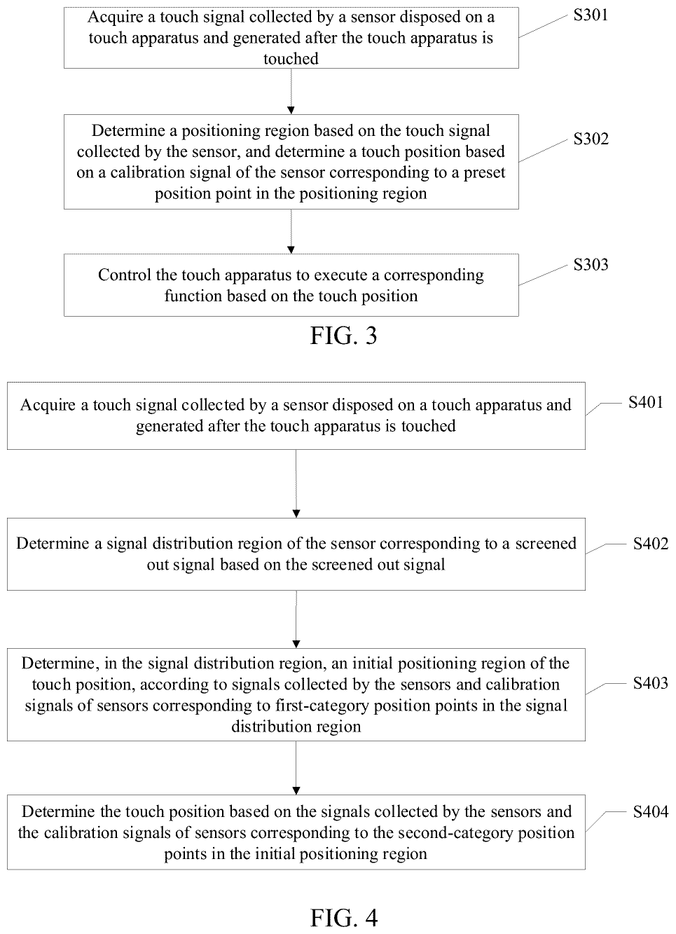

Embodiments of the present disclosure provide a touch positioning method, as shown in FIG. 3, and the method includes:

Step S301: acquiring a touch signal collected by a sensor disposed on a touch apparatus and generated after the touch apparatus is touched;
wherein a quantity of the sensor(s) disposed on the touch apparatus may be one or more, and a plurality of sensors can be arranged symmetrically or asymmetrically.

The sensors include piezoelectric sensor, strain sensor, acceleration sensor, etc., and the piezoelectric sensors include piezoelectric ceramic sensor, piezoelectric film sensor, piezoelectric crystal sensor, or a sensor with piezoelectric effect.

Step S302: determining a positioning region based on the touch signal collected by the sensor, and determining a touch position based on a calibration signal of the sensor corresponding to a preset position point in the positioning region.

Step S303: controlling the touch apparatus to execute a corresponding function based on the touch position.

There are various ways to control the touch apparatus to execute the corresponding function based on the touch position. Exemplarily, a touch panel is divided into a plurality of regions, each region corresponds to a function, and a function corresponding to the region in which the touch position falls is executed. Or, based on a number of times that the touch position appears in a same region within a preset time, a function corresponding to the number of times is executed, e.g., in a same region, a single click corresponds to one function and a double click corresponds to another function.

The technical solutions recorded in the present disclosure uses touch signals which are generated after the touch apparatus is touched and collected by sensors and calibration signals of the sensors corresponding to preset touch position points to perform touch positioning, which is equivalent to limiting a positioning range in a positioning process, which improves a positioning accuracy.

Embodiments of the present disclosure further provide another touch positioning method, as shown in FIG. 4, the method includes:

Step S401: acquiring a touch signal collected by a sensor disposed on a touch apparatus and generated after the touch apparatus is touched;

A quantity of the sensor disposed on the touch apparatus may be one or more, and a plurality of sensors can be arranged symmetrically or asymmetrically.

Step S402, screening out the touch signal, and determining a signal distribution region of a sensor corresponding to the screened out touch signal.

In an exemplary embodiment, a signal that meets a preset condition may be screened out from touch signals collected by the sensor, wherein the signal that meets the preset condition include one or more of the following:
a wave peak value of a specified signal exceeds a preset peak value;
a wave trough value of the specified signal is lower than a preset trough value;
an amplitude of the specified signal in an upward trend exceeds a preset amplitude threshold;
when there are touch signals collected by a plurality of sensors, an amplitude of the specified signal at a same collection time moment is the largest.

Here, the specified signal may be an originally collected touch signal or a signal obtained after performing mathematical processing on the originally collected touch signal, such as performing an integration operation on the collected touch signal.

Exemplarily, at a same collection time moment, multiple channels of touch signals from four sensors are collected as X={s1(t) s2(t) s3(t) s4(t)}, t represents the collection time moment, and signals s1(t) to s4(t) correspond to signals from the first sensor to the fourth sensor, respectively, where s1(t) has a maximum wave peak, then the signal s1(t) is screened out from X.

According to the screened out touch signal, a signal distribution region corresponding to the touch signal is determined, and the signal distribution region where the touch position is most likely to be located.

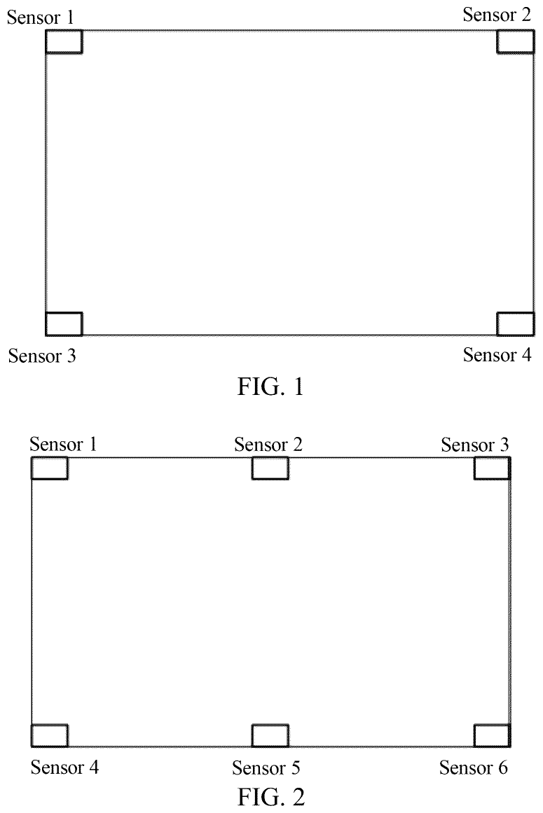

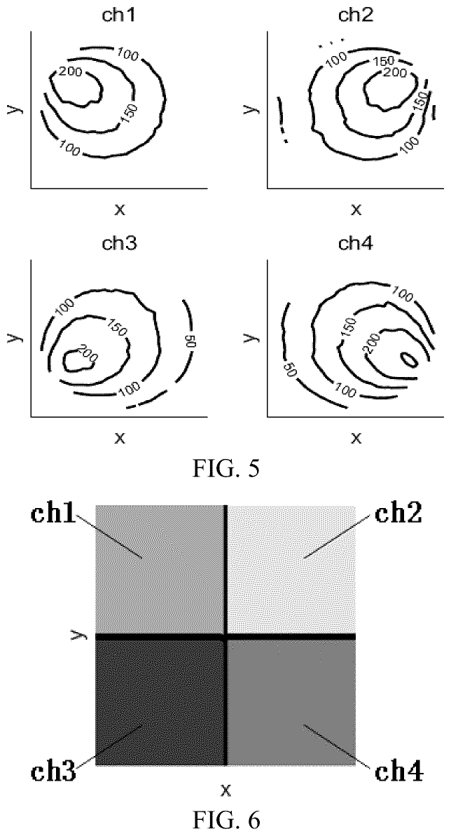

FIG. 5 shows a schematic diagram of a signal distribution of four sensors arranged symmetrically, and the schematic diagram of the four sensors arranged symmetrically can be referred to FIG. 1. In FIG. 5, ch1 to ch4 represent signals from the sensors 1 to 4 respectively, and numbers 50, 100, 150 and 200 represent signal magnitude values respectively, and signal magnitudes having a same value form a signal contour.

FIG. 6 shows a schematic diagram of a signal distribution region of four sensors arranged symmetrically. Similarly, the schematic diagram of the four sensors arranged symmetrically can be referred to FIG. 1.

Exemplarily, when the signal s1(t) is screened out according to step S402, since s1(t) is a signal from ch1, a signal distribution region of ch1 can be determined;

Next, continue to locate the touch position in the determined signal distribution region.

Step S403: determining, in the signal distribution region, an initial positioning region of the touch position, according to touch signals collected by the sensors and calibration signals of the sensors corresponding to preset first-category position points in the signal distribution region;

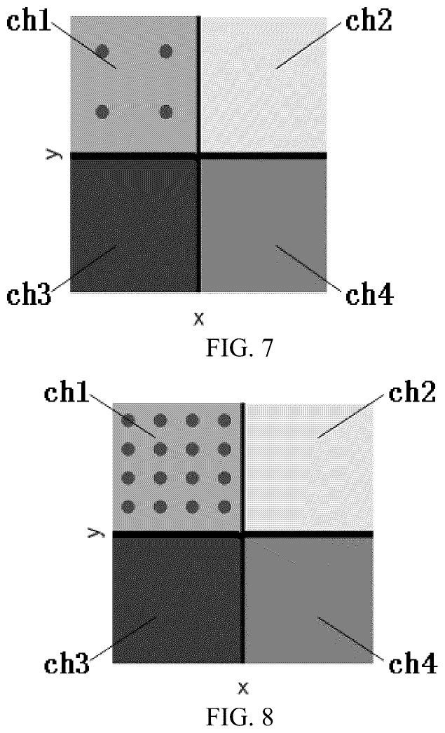

FIGS. 7 and 8 respectively show examples of two types of preset first-category position points in FIG. 7, there are 4 first-category position points in total in 2 rows and 2 columns in the signal distribution region of ch1, and in FIG. 8, there are 16 first-category position points in total in 4 rows and 4 columns in the signal distribution region of ch1. Small spacing between the first-category position points and their large distribution numbers can improve positioning accuracy, but also result in a larger computation load.

As one implementation mode, the first-category position points with a small distribution density (that is, a large spacing between position points) can be selected first to perform initial locating of the position; subsequently, second-category position points with a large distribution density can be selected to finely locating the position to meet precise positioning and the computation load can be reduced. The first-category position points and the second-category position points can be determined by pre-pointing.

When a first-category position point is touched, a signal from a sensor can be obtained, and the signal is used as a calibration signal.

Exemplarily, based on a signal from the sensor obtained from actual touching (an exact position of the touching is unknown, but it is known that the touching is most likely located within the signal distribution region of ch1) and a calibration signal obtained from touching each of the first-category position points (the touch position thereof is preset) in the signal distribution region of the ch1, it is possible to determine which of the first-category position points the touch position is close to, and further determine an initial positioning region of the touch position.

Step S404: continuing to determine the touch position in the initial positioning region based on the touch signals collected by the sensors and the calibration signals of the sensor corresponding to the preset second-category position points in the initial positioning region.

An embodiment of the present disclosure provides a touch positioning method, which uses a touch signal which is generated after the touch apparatus is touched and collected by a sensor, and calibration signals of the sensor corresponding to a plurality of categories of preset touch positions to judge a touch position, and gradually shrinks a positioning region in the judgment process to find the touch position, thereby improving the positioning accuracy.

In an exemplary embodiment, the determining, in the signal distribution region, the initial positioning region of the touch position, according to the touch signals collected by the sensors and the calibration signals of the sensors corresponding to the first-category position points in the signal distribution region includes:
comparing distance values between the touch signals collected by the sensors and calibration signals of sensors corresponding to all or part of the first-category position points; taking a first position point with a distance value meeting a preset requirement as an initial position point; for example, assuming that there exists 12 first-category position points in total in the signal distribution region, a calibration signal of a sensor corresponding to each of the 12 first category of position points may be selected to be taken into calculation of the distance value, or, calibration signals of sensors corresponding to part of the first-category position points (e.g., 6 first-category position points) may be selected to be taken into calculation of the distance value; and
determining the initial positioning region according to the initial position point.

In an exemplary embodiment, the comparing the distance value between the touch signals collected by the sensors and the calibration signals of the sensors corresponding to all or a part of the first-category position points, and taking the first position point with the distance value meeting the preset requirement as the initial position point includes:
composing the touch signals collected by the sensors into a real-time signal vector;
composing the calibration signals of the sensors corresponding to all or part of the first-category position points respectively into a position signal vector; that is to say, each first-category position point of all or part of the first-category position points corresponds to one position signal vector;
comparing a distance between the real-time signal vector and all or part of the formed position signal vectors, respectively; and
taking a first-category position point with a distance meeting a preset requirement as the initial position point, exemplarily, a first-category position point with the smallest distance is taken as the initial position point.

Exemplarily, taking the distance as a cosine distance as an example, the real-time signal vector is set as X={s1(t) s2(t) s3(t) s4(t)}, abbreviated as X={s1 s2 s3 s4}; a calibration signal corresponding to an i-th first-category position point is Yᵢ={s1i′ s2i′ s3i′ s4i′}; where i may be any one of all of the first-category position points, or any one of part of the first-category position points;
then the cosine distance between X and Yᵢ is

$${D}_{i} = 1 - \frac{s 1 * s {1}_{i}^{′} + s 2 * s {2}_{i}^{′} + s 3 * s {3}_{i}^{′} + s 4 * s {4}_{i}^{′}}{\sqrt{s {1}^{2} + s {2}^{2} + s {3}^{2} + s {4}^{2}} * \sqrt{s {1}_{i}^{′2} + s {2}_{i}^{′2} + s {3}_{i}^{′2} + s {4}_{i}^{′2}}} ;$$

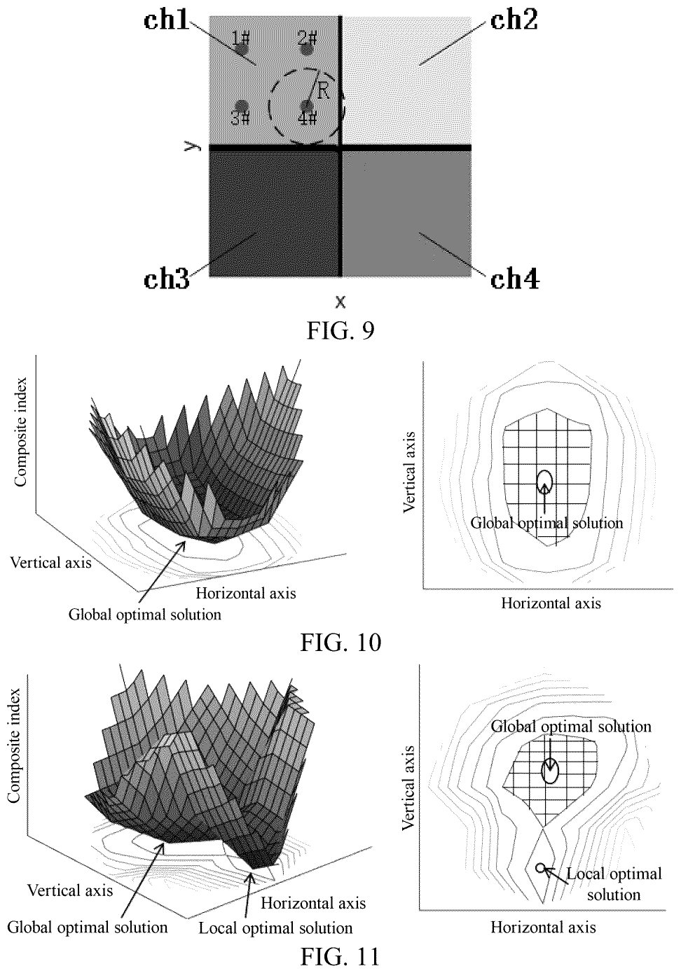

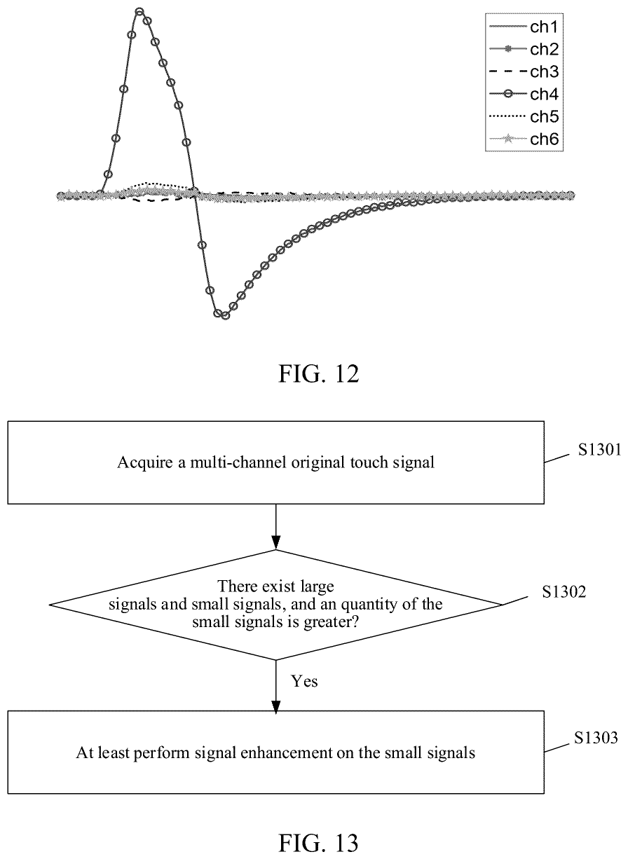

and
comparing magnitudes of all or part of Dᵢ, and taking a position point corresponding to a smallest Dᵢ as the initial position point. As shown in FIG. 9, a first-category position point labeled 4 # is a determined the initial position point, and a cosine distance between a calibration signal obtained by touching this point position and the real-time signal is the smallest.

In an exemplary embodiment, the determining the initial positioning region based on the initial position point includes:
taking a region with a specified shape containing the initial position point as the initial positioning region;
wherein the initial position point is a designated point (such as center point, center of gravity or weighted average center point, etc) of the region with the specified shape, or the initial position point is another position point in the region with the specified shape obtained according to a preset position algorithm.

Types of the region with the specified shape may include: a circle and a square.

Referring further to FIG. 9, a circle is drawn with the initial position point represented by 4 # as a center of the circle and a preset distance R as a radius of the circle, and a resulting circular region is the initial positioning region.

In an exemplary embodiment, the continuing to determine the touch position in the initial positioning region based on the touch signals collected by the sensors and the calibration signals of the sensor corresponding to the preset second-category position points in the initial positioning region includes:
comparing distance values between the touch signals collected by the sensors and calibration signals of sensors corresponding to all or part of the second-category position points respectively, to obtain first distance values;
comparing a first signal with all or part of second signals, respectively, to obtain second distance values, wherein the first signal is used to characterize a magnitude relationship between the touch signals collected by the sensors; wherein when one sensor is provided and the touch signal collected by the sensor is a single-channel touch signal, the first signal is the touch signal collected by the sensor, and when a plurality of sensors are provided and the touch signals collected by the sensors are multiple channels of touch signals, the first signal characterizes a magnitude relationship among the multiple channels of touch signals; a second signal is used to a magnitude relationship between the calibration signals of the sensors corresponding to the second-category position points;
determining a composite index value for all or part of the second-category position points based on the first distance value and the second distance value corresponding to each of the second-category position points; and
determining the touch position based on composite index values corresponding to all or part of the second-category position points.

In an embodiment of the present disclosure, not only distances between the collected touch signals and the calibration signals are considered, but also a distance between the magnitude relationship between the collected touch signals and the magnitude relationship between the calibration signals are considered when performing fine locating of the touch position, so that a touch signal with a smallest distance from the calibration signal can be selected, thereby improving the positioning accuracy.

In an exemplary embodiment, a method for acquiring the first signal includes:
pairwise comparing the touch signals collected by the sensors, and forming each comparison result into the first signal;
assigning the comparison result as a first value when the comparison result is “greater than”;
assigning the comparison result as a second value when the comparison result is “less than”; and
assigning the comparison result as a third value when the comparison result is “equal”;
wherein the first value, the second value, and the third value are all different, for example, the first value is 1, the second value is −1, and the third value is 0. For example, assuming X={s1 s2 s3 s4}={1 3 2 4}, then the first signal is {−1(1<3)−1(1<2)−1(1<4) 1(3>2)−1(3<4)−1(2<4)}.

In an exemplary embodiment, a method for acquiring the second signal includes:
pairwise comparing calibration signals of sensors corresponding to each of all or part of the second-category position points, and forming each comparison result into the second signal;
assigning the comparison result as a first value when the comparison result is “greater than”;
assigning the comparison result as a second value when the comparison result is less than”; and
assigning the comparison result as a third value when the comparison result is “equal”;
wherein the first value, the second value and the third value are all different, the first value is 1, the second value is −1, and the third value is 0.

In an exemplary embodiment, the comparing the first signal with all or part of the second signals respectively, to obtain the second distance values includes:
calculating a Euclidean distance between the first signal and each of all or part of the second signals to obtain a plurality of Euclidean distance values.

Assuming that the multiple channels of touch signals collected by the plurality of sensors is X={s1 s2 s3 s4}, the first signal obtained from X is X1; a calibration signal corresponding to an i-th first-category position point is Yᵢ={s1ᵢ′ s2ᵢ′ s3ᵢ′ s4ᵢ′}, a second signal obtained from Yᵢ is Y1ᵢ, and an Euclidean distance between the first signal and an i-th second signal is

$${G}_{i} = \sqrt{{\sum }_{g = 1}^{m} {( X {1}_{g} - Y {1}_{ig} )}^{2}} ,$$

where m is a length of X1 and Y1ᵢ, m=Cₙ²=C₄²=6 and n is a length of X and Yᵢ.

In an exemplary embodiment, the determining the composite index value for each of the all or part of the second-category position points based on the first distance value and the second distance value corresponding to each of the second-category position points includes:
taking a product of the first distance value and the second distance value corresponding to each of the all or part of the second-category position points as the composite index value for each of the second-category position points; exemplarily, a composite index value corresponding to an i-th second-category position point is represented by Zᵢ, then Zi=Dᵢ*Gi.

In an exemplary embodiment, the determining the touch position based on the composite index values corresponding to all or part of the second-category position points includes:
establishing a mapping relationship model between a second-category position point in the initial positioning region and the composite index value for the second-category position point based on the composite index values corresponding to all or part of the second-category position points; and
determining a quantity of minimum values for a composite index based on the mapping relationship model, and determining the touch position based on the quantity.

In an exemplary embodiment, the determining the touch position based on the quantity includes:
when the quantity of the minimum values is only one, determining a plurality of second-category position points based on the mapping relationship model, wherein distances between the plurality of second-category position points and a second-category position point directly corresponding to the minimum value meets a preset distance requirement, e.g., the distances are less than a first preset distance threshold, and the composite index values corresponding to the plurality of second-category position points meets a preset composite index requirement, e.g., the composite index values are less than a first preset composite index; and
calculating a center position of a region formed by the plurality of second-category position points, and determining the center position as the touch position.

FIG. 10 shows a schematic diagram of a model with only one minimum value, vertical and horizontal axes in the diagram together characterize position points. Herein, a region covered by grid lines in the right figure is a region composed of a plurality of determined second-category position points, and a center point of this region is a global optimal solution, that is, a position where the touching occurs. The center point of the region is selected as the touch position, which also reduces the computational complexity.

In another exemplary embodiment, the determining the touch position based on the quantity includes:

When the quantity of the minimum values is not only one, for all or part of the minimum values, determining a plurality of second-category position points corresponding to each of the minimum values based on the mapping relationship model, wherein distances between the plurality of second-category position points and a second-category position point directly corresponding to the minimum value meets a preset distance requirement, e.g., the distances are less than a second preset distance threshold, and composite index values corresponding to the plurality of second-category position points meet a preset composite index requirement; for example, the composite index values are less than a second preset composite index threshold;
determining a size of a region form by the plurality of second-category position points and a magnitude of a composite index of the region; and
determining the touch position based on a size of a region determined by all or part of the minimum values and a magnitude of a composite index of the determined region.

In an exemplary embodiment, determining the magnitude of the composite index of the region includes:

calculating an average value of weights of composite indexes corresponding to second-category position points in the region.

In an exemplary embodiment, the determining the touch position based on the size of the region determined by all or part of the minimum values and the magnitude of the composite index of the determined region includes:
calculating a product of an area of all or part of the determined region and an average value of the weighs of the composite indexes of the region, or calculating a sum of an area of all or part of the determined region and an average value of the weighs of the composite indexes of the region; and
determining the touch position as a center position of a region corresponding to a calculation result that meets a preset requirement, for example, a center position of a region corresponding to a largest calculation result is determined as the touch position.

Exemplarily, assuming that there are P position points in the region participating in the calculation of weights of composite indexes, a weight corresponding to an i-th position point can be expressed as:

$${w}_{i} = ( 1 - \frac{{Z}_{i}}{{\sum }_{i = 1}^{P} {Z}_{i}} ) / ( P - 1 ) ,$$

wherein Zᵢ represents a composite index value corresponding to the i-th position point; and
the average value of the weights in the region can be expressed as

$$\overline{w} = {\sum }_{i = 1}^{P} {w}_{i} / P ;$$

as an example, P≥3.

FIG. 11 shows a schematic diagram of a model with two minimum values, indicating that there is a local optimal solution and a global optimal solution, and judgment is continued to determine the global optimal solution therefrom; after the judgment, a region covered by grid lines in the right figure is the region where with a product of an area of the region and an average value of weighs of composite indexes in the region being the largest, and a center point of the region is the global optimal solution, that is, a position where the touching occurs.

Based on test data, using the touch positioning determination method recorded in the above-described embodiments of the present disclosure, a positioning error≤1.2 mm is achieved in a two-dimensional touch region of 50 mm*50 mm. The positioning error is a distance difference between a two-dimensional position calculated and determined by the described method and an actual two-dimensional position.

In order to increase the accuracy of touch positioning, a quantity of sensors provided can be increased. However, due to various factors such as cost and a volume of the touch apparatus, the quantity of sensors arranged on the touch apparatus is limited, resulting in only a few touch signals with large signal magnitudes may be obtained when an edge region of a touch screen is touched. As shown in FIG. 2, 6 sensors are arranged on a touch screen, when an edge position of the touch screen close to the fourth sensor is touched, only one touch signal from sensors with a large signal magnitude is obtained (that is, a touch signal from the fourth sensor), and signal magnitudes of touch signals collected by remaining five sensors all are very small. Due to an insufficient quantity of touch signals collected by sensors that meet a requirement of signal magnitude, this in turn results in poor accuracy of edge touch positioning based on touch signals collected by sensors.

Embodiments of the present disclosure provide a method for acquiring a touch signal collected by a sensor, the method is applied to a situation that there are a plurality of sensors, as shown in FIG. 13, the method includes:

Step S1301: acquiring a multi-channel original touch signal;

In embodiments of the present disclosure, one channel of original touch signal comes from one sensor, and different channels of original touch signals come from different sensors. for example, the touch apparatus is provided therein with 6 sensors, and a 6-channel original touch signal can be obtained from the 6 sensors;

Step S1302, judging whether there is large signals and small signals in the multi-channel original touch signal, and an quantity of the small signals is greater than a preset signal quantity; when there is the large signals and the small signals, and the quantity of the small signals is greater than the preset signal quantity, performing step S1303;
wherein a large signal refers to a signal with a signal-to-noise ratio greater than a preset signal-to-noise ratio threshold, and a small signal refers to a signal with a signal-to-noise ratio less than the preset signal-to-noise ratio threshold, and the preset signal-to-noise ratio threshold can be set according to actual situations;
the quantity of the small signals can be determined according to a quantity of channels to which the small signals belong. For example, if small signals in the 6-channel original touch signal come from 5 channels, the quantity of the small signals is 5;

Step S1303: performing processing on the multi-channel original touch signal, and taking a processed multi-channel original touch signal as touch signals collected by sensors, that is, a multi-channel control signal.

The performing processing on the multi-channel original touch signal includes:
at least performing signal enhancement on the small signals, including:
performing the signal enhancement on the entire multi-channel original touch signal, or performing the signal enhancement on only the small signals.

In the method recorded in embodiments of the present disclosure, when a quantity of small signals in the multi-channel original touch signal is too large, the signal enhancement processing is performed at least on the small signals, so that a signal quality of a processed multi-channel original touch signal is improved, which in turn improves the accuracy of positioning according to the processed multi-channel original touch signal.

In an exemplary embodiment, a method for performing the signal enhancement includes:
first performing a grayscale expansion processing on the signal by a preset first structural element K1*N, and then performing a grayscale closure operation on the signal after the grayscale expansion processing by a preset second structural element K2*N, where K1 and K2 are preset values, and N is a quantity of the sensors (i.e., a quantity of channels) or a quantity of the small signals; when N is the quantity of the plurality of sensors, correspondingly the signal enhancement is performed on the entire multi-channel original touch signal; when N is the quantity of the small signals, correspondingly, the signal enhancement is only performed on the small signals.

The grayscale closure operation refers to grayscale expansion followed by grayscale corrosion. The grayscale expansion and the grayscale erosion are two basic operations in morphological image processing, which are used to improve the structure and shape of an image. Embodiments of the present disclosure turn the operations applied to image processing to electrical signal processing, and an intensity of a signal can be changed under the condition that a basic shape of the signal remains unchanged through the grayscale expansion operation, which is conducive to subsequent signal analysis and recognition; and noise mixed within the small signals can be removed by the grayscale closure operation.

Structural elements are basic tools in morphological operations. Using different shapes of structural elements can emphasize or suppress corresponding image features, which in turn affects results of the grayscale expansion and erosion operations.

In an exemplary embodiment, the multi-channel original touch signal from a plurality of sensors is a sine wave signal, and in order to enhance sine wave characteristics of the multi-channel original touch signal, the first structural element and the second structural element may be sinusoidal or semicircular.

The shapes of the first structural element and the second structural element may be the same or different, exemplarily, the first structural element is sinusoidal and the second structural element is semicircular; or, the first structural element is sinusoidal and the second structural element is also sinusoidal; or the first structural element is semicircular, and the second structural element is also semicircular.

In an exemplary embodiment, the acquiring the multi-channel original touch signal includes:
receiving sampling frames of the multi-channel original touch signal; wherein each sampling frame includes a multi-channel original touch signal at a same sampling time moment;
performing consistency measurement on a current sampling frame and an adjacent sampling frame, and when it is judged that the two frames participating in the consistency measurement meet a consistency requirement, taking the current sampling frame as a starting signal of the multi-channel original touch signal; wherein both the current sampling frame and the adjacent sampling frame are M-dimensional data frames, and M is equal to the quantity of the plurality of sensors.

Since a sampling frame signal may also be an interference signal, the interference signal can be excluded through the consistency measurement, ensuring as much as possible that an acquired multi-channel original touch signal is a non-interference signal. Through the consistency measurement, it is possible to avoid selection of a multi-channel original touch signal with excessive fluctuations, and ensure that the acquired multi-channel original touch signal is a stable signal; through the consistency measurement, a continuous signal can be acquired, and the continuous signal has a strong anti-interference capability, which can improve anti-interference performance of the acquired multi-channel original touch signal. Since a consistent and continuous signal is easier to be processed and analyzed by computers, the subsequent analysis of the acquired multi-channel original touch signal can be more accurate and efficient through the consistency measurement.

Exemplary, the multi-channel original touch signal is a voltage signal responsive to a touch operation. The current sampling frame and its adjacent sampling frame are measured for consistency, which refers to a consistency between a voltage signal vector of the current frame and a voltage signal vector of its adjacent frame in terms of voltage values.

In an exemplary embodiment, the judging that the two frames participating in the consistency measurement meet the consistency requirement may include:
performing a dot product operation on the two frames participating in the consistency measurement; and
judging whether a result of the dot product operation meets a preset consistency requirement (for example, less than a preset consistency threshold), and when the result of the dot product operation meets the preset consistency requirement, it is determined that the two frames participating in the consistency measurement meet the consistency requirement.

In another exemplary embodiment, the judging that the two frames participating in the consistency measurement meet the consistency requirement may include:
dimensionality-reducing one of the frames participating in the consistency measurement from an M-dimensional vector to a K-dimensional vector by a preset first projection matrix, where 1≤K<M, and M is equal to the quantity of the plurality of sensors; exemplarily, K is equal to the result of rounding M/2, e.g., if M=6, then K=3; dimensionality-reducing another frame participating in the consistency measurement from an M-dimensional vector to a K-dimensional vector by a preset second projection matrix; for example, a sampling frame signal from 6 channels at time (t−1) is Xₜ₋₁ (the dimension is 6, with 1 row and 6 columns), the sampling frame signal from the 6 channels at time t is Xₜ (the dimension is also 6, with 1 row and 6 columns), the preset first projection matrix Wₜ₋₁ and the preset second projection matrix W, are both matrices with 6 rows and 3 columns, then Xₜ₋₁Wₜ₋₁ obtained after the dimensionality reduction is a 3-dimensional vector, and XₜWₜ is a 3-dimensional vector;
performing a dot product operation on the two frames after the dimensionality reduction; and
judging whether a result of the dot product operation meets a preset consistency requirement, and when the result of the dot product operation meets the preset consistency requirement, it is determined that the two frames participating in the consistency measurement meet the consistency requirement.

The first projection matrix and the second projection matrix on which a dimensionality reduction operation is performed may be the same or may not be the same. In the embodiment, the dimensionality reduction operation is first performed on two frames participating in the consistency measurement through projection matrices, and then the dot product operation is performed, so that a computation load of the dot product operation can be reduced.

Considering that the inconsistency of two frames signals that do not have consistency becomes more obvious after the difference is amplified with respect to two frames signals that have consistency, in an exemplary embodiment, a difference value between the first projection matrix and the second projection matrix can be set to meet a preset difference requirement (for example, greater than a preset difference threshold) to amplify the difference between the signals that have been dimensionality-reduced by the first projection matrix and the second projection matrix, respectively, making it easier to exclude the two frame of signals that do not have consistency. Exemplarily, the difference value between the first projection matrix and the second projection matrix can be obtained by calculating a distance between the two projection matrices, and a distance between two matrices can be calculated in a variety of ways, such as by using the Frobenius paradigm or the Euclidean distance. Therefore, the first projection matrix can be determined first, and then the second projection matrix can be deduced using a distance calculation formula based on a set distance value greater than the preset difference threshold.

When determining the first projection matrix, original touch signals of the whole touch surface can be obtained first, and then the first projection matrix can be obtained according to the principle that a proportion difference of original touch signals obtained from a same touch position is as small as possible after dimensionality reduction by the first projection matrix, and a proportion difference of two original touch signals obtained from different touch positions is as large as possible after dimensionality reduction by the first projection matrix; and a determined first projection matrix is not unique.

In addition, considering that proportional consistency of some signals is also related to the touch force, in an exemplary embodiment, a ratio between the first projection matrix and the second projection matrix may be set to be proportional to a force ratio, the force ratio refers to a ratio of a force value determined based on the one of the frames to a force value determined based on the other frame. For example, assuming that a sampling frame signal at time (t−1) is [A₁₍ₜ₋₁₎, A₂₍ₜ₋₁₎, A₃₍ₜ₋₁₎, A₄₍ₜ₋₁₎, A₅₍ₜ₋₁₎, A₆₍ₜ₋₁₎], the force value at that time is calculated and recorded as Fₜ₋₁ through calculating the relationship between the signal magnitude and the force; the sampling frame signal at time t is [A₁ₜ, A₂ₜ, A₃ₜ, A₄ₜ, A₅ₜ, A₆ₜ]. Similarly, the calculated force value at that time is recorded as Fₜ, the projection matrix corresponding to the sampling frame signal at time t is set as Wₜ, and the projection matrix corresponding to the sampling frame signal at time (t−1) is adjusted according to the force as W₍ₜ₋₁₎=Wₜ*(Fₜ₋₁/Fₜ).

In an exemplary embodiment, the performing processing on the multi-channel original touch signal in step S1303 further includes:
before at least performing the signal enhancement on the small signals, performing an interpolation processing on the acquired multi-channel original touch signal in the time domain, for example, an interpolation processing is performed on each channel original touch signal of the acquired multi-channel original touch signal in the time domain.

Exemplarily, interpolation methods used in the time domain may include a linear interpolation method or a cubic spline interpolation method;

Exemplarily, assuming that the 6-channel original touch signal before the interpolation is

$$[ \begin{matrix}{A}_{1 ( t - 1 )} & {A}_{1 t} \\ {A}_{2 ( t - 1 )} & {A}_{2 t} \\ {A}_{3 ( t - 1 )} & {A}_{3 t} \\ {A}_{4 ( t - 1 )} & {A}_{4 t} \\ {A}_{5 ( t - 1 )} & {A}_{5 t} \\ {A}_{6 ( t - 1 )} & {A}_{6 t}\end{matrix} ] ,$$

the 6-channel original touch signal after the interpolation may be

$$[ \begin{matrix}{A}_{1 ( t - 1 )} & {A}_{1}^{′} & {A}_{1 t} \\ {A}_{2 ( t - 1 )} & {A}_{2}^{′} & {A}_{2 t} \\ {A}_{3 ( t - 1 )} & {A}_{3}^{′} & {A}_{3 t} \\ {A}_{4 ( t - 1 )} & {A}_{4}^{′} & {A}_{4 t} \\ {A}_{5 ( t - 1 )} & {A}_{5}^{′} & {A}_{5 t} \\ {A}_{6 ( t - 1 )} & {A}_{6}^{′} & {A}_{6 t}\end{matrix} ] ,$$

and [A₁′ A₂′ A₃′ A₄′ A₅′ A₆′] is an interpolation signal.

Due to the limitation of various factors such as chip operating frequency and power consumption, the signal sampling rate is limited, and a quantity of sampling signals obtained may be relatively small. By signal interpolating original touch signals of each channel in the time domain, a quantity of touch signals of each channel can be increased, and the accuracy of subsequent analysis or processing on the multi-channel original touch signal can be improved.

In an exemplary embodiment, the performing processing on the multi-channel original touch signal in step S1303 further includes:
after at least performing signal enhancement on the small signals, performing a scaling operation on the multi-channel original touch signal acquired, such that a scaled multi-channel original touch signal is within a preset signal range, for example, the scaling operation is performed on each original touch signal of each channel.

In this embodiment, by scaling the multi-channel original touch signal through the scaling operation, the multi-channel original touch signal can be locked within a preset signal range, which is convenient for subsequent processing on the multi-channel original touch signal based on a same reference. In addition, placing the multi-channel original touch signal in a same signal range reduces difference between data and is also conducive to algorithm stability during processing.

A basic criterion for performing the scaling operation on the multi-channel original touch signal acquired is: scaling down a large signal and scaling up a small signal.

In an exemplary embodiment, the performing the scaling operation on the multi-channel original touch signal acquired includes:
when the original touch signal is a small-amplitude signal, performing a scaling-up operation on the original touch signal by an exponential operation; and
when the original touch signal is a large-amplitude signal, performing a scaling-down operation on the original touch signal by a logarithmic operation;
wherein the small-amplitude signal refers to a signal with an amplitude whose absolute value is less than a preset amplitude threshold, and the large-amplitude signal refers to a signal with an amplitude whose absolute value is greater than the preset amplitude threshold.

The original touch signal exists as a positive amplitude signal and a negative amplitude signal. When the original touch signal is a negative amplitude signal, the scaling-up operation on the original touch signal refers to scaling up the absolute value of the signal and keeping the sign unchanged.

In another exemplary embodiment, the performing the scaling operation on the multi-channel original touch signal includes:
performing a scaling-up operation on the original touch signal when an absolute value of an amplitude of the original touch signal is located in a first preset interval;
keeping the original touch signal unchanged when the absolute value of the amplitude of the original touch signal is located in a second preset interval; and
performing a scaling-down operation on the original touch signal when the absolute value of the amplitude of the original touch signal is located in a third preset interval;
wherein values of the first preset interval, the second preset interval, and the third preset interval gradually increase.

In an exemplary embodiment, the performing processing on the multi-channel original touch signal in step S1303 further includes:
after at least performing signal enhancement on the small signals, performing consistency measurement on a sampling frame (exemplarily, each fame) of the multi-channel original touch signal and its adjacent frame sequentially, and when judging that two frames participating in the consistency measurement meet a consistency requirement, the sampling frame is taken as a valid frame; and
combining original touch signals of all valid frames.

The combining the original touch signals of all the valid frames includes:
a multi-frame addition (accumulation) operation by which an intensity or signal-to-noise ratio of a signal can be increased; in this embodiment, the multi-frame addition operation refers to addition of original touch signals from a same channel between multiple frames; and
a multi-frame averaging operation, wherein the multi-frame averaging operation refers to taking an average value after a multi-frame addition operation, through which influence of random noise can be reduced and the stability of the signal can be improved. In this embodiment, the multi-frame averaging operation refers to taking an average value of the original touch signals of each channel after the multi-frame addition operation, respectively.

Exemplarily, assuming that the multi-channel original touch signal obtained after at least performing the signal enhancement on the small signals is

$$[ \begin{matrix}{A}_{1 ( t - 1 )} & {A}_{1}^{′} & {A}_{1 t} \\ {A}_{2 ( t - 1 )} & {A}_{2}^{′} & {A}_{2 t} \\ {A}_{3 ( t - 1 )} & {A}_{3}^{′} & {A}_{3 t} \\ {A}_{4 ( t - 1 )} & {A}_{4}^{′} & {A}_{4 t} \\ {A}_{5 ( t - 1 )} & {A}_{5}^{′} & {A}_{5 t} \\ {A}_{6 ( t - 1 )} & {A}_{6}^{′} & {A}_{6 t}\end{matrix} ] ,$$

[A₁₍ₜ₋₁₎ A₂₍ₜ₋₁₎ A₃₍ₜ₋₁₎ A₄₍ₜ₋₁₎ A₅₍ₜ₋₁₎ A₆₍ₜ₋₁₎] is determined to not meet the consistency requirement after the consistency judgment, the frame is not a valid frame, a valid frame participating in the frame combination is

$$[ \begin{matrix}{A}_{1}^{′} & {A}_{1 t} \\ {A}_{2}^{′} & {A}_{2 t} \\ {A}_{3}^{′} & {A}_{3 t} \\ {A}_{4}^{′} & {A}_{4 t} \\ {A}_{5}^{′} & {A}_{5 t} \\ {A}_{6}^{′} & {A}_{6 t}\end{matrix} ] ,$$

and the signal after the multi-frame combination is

$$[ \begin{matrix}{A}_{1}^{′} + {A}_{1 t} \\ {A}_{2}^{′} + {A}_{2 t} \\ {A}_{3}^{′} + {A}_{3 t} \\ {A}_{4}^{′} + {A}_{4 t} \\ {A}_{5}^{′} + {A}_{5 t} \\ {A}_{6}^{′} + {A}_{6 t}\end{matrix} ] .$$

The method for acquiring touch signals collected by a plurality of sensors recorded in embodiments of the present disclosure will be explained by example below.

### Example One

Receiving sampling frame signals of a multi-channel original touch signal;

After receiving a plurality of sampling frame signals, performing consistency measurement on a current sampling frame and its previous sampling frame, and when the two frames meet a consistency requirement, taking the current sampling frame as a starting signal of the multi-channel original touch signal for processing;

Starting from the starting signal, taking each frame satisfying a condition as a frame signal to be processed; the satisfying the condition refers to: there are large signals and small signals in the multi-channel original touch signal in the frame, and the quantity of the small signals is greater than a preset signal quantity;

Based on all frame signals to be processed, the following operations are performed:

Performing an interpolation processing on the original touch signal of each channel in the time domain;

Performing signal enhancement processing on the multi-channel original touch signal after the interpolation processing;

Performing scaling processing on the multi-channel original touch signal after the enhancement processing according to an amplitude of each signal;

Performing consistency measurement on the multi-channel original touch signal after the scaling processing frame by frame, screening out frame signals that do not meet the consistency requirement, and retaining valid frames that meet the consistency requirement. The consistency measurement is performed while determining the starting signal, however, in order to avoid consistency changes in subsequent sampling frames due to interference of factors such as temperature drift and environmental disturbance, or consistency changes triggered by the subsequent signal processing process (such as interpolation operation), the consistency judgment can be performed again;

Summing original touch signals of all valid frames according to channels to obtain the touch signals collected by the plurality of sensors, i.e., a multi-channel touch signal;

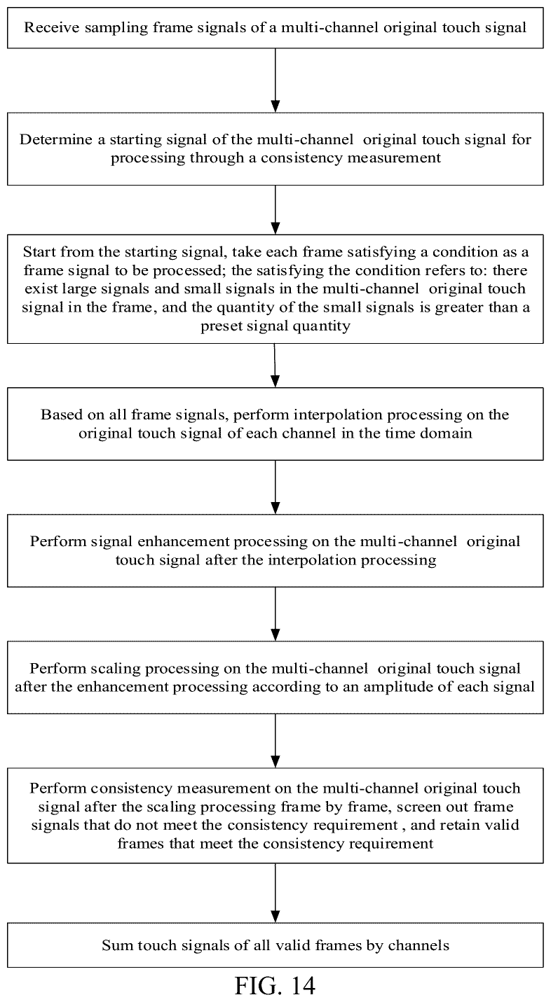

The above acquisition process is as shown in FIG. 14.

### Example Two

Receiving sampling frame signals of a multi-channel original touch signal;

After receiving a plurality of sampling frame signals, performing consistency measurement on a current sampling frame and its previous sampling frame, and when the two frames meet the consistency requirement, taking the current sampling frame as a starting signal of the multi-channel original touch signal for processing;

Starting from the starting signal, taking each frame satisfying a condition as a frame signal to be processed; the satisfying the condition refers to: there are large signals and small signals in the multi-channel original touch signal in the frame, and the quantity of the small signals is greater than a preset signal quantity;

Based on all frame signals to be processed, the following operations are performed:

Performing interpolation processing on the original touch signal of each channel in the time domain;

Performing signal enhancement processing on the multi-channel original touch signal after the interpolation processing;

Performing consistency measurement on the multi-channel original touch signal frames after the signal enhancement processing, screening out frame signals that do not meet the consistency requirement, and retaining valid frames that meet the consistency requirement;

Performing scaling processing on valid frames satisfying consistency enhancement according to an amplitude of each signal; and

Summing original touch signals after the scaling processing according to channels, to obtain the touch signals collected by the plurality of sensors, i.e., a multi-channel touch signal.

The touch positioning method recorded in embodiments of the present disclosure will be explained by example below.

Determining a touch signal with a largest amplitude from touch signals collected by a plurality of sensors; wherein the touch signals collected by the plurality of sensors are obtained according to the method recorded in the embodiment of the present disclosure described above;

Embodiments of the present disclosure further provide a non-transient computer-readable storage medium storing program instructions that, when executed, can implement the touch positioning method as described in any of previous embodiments.

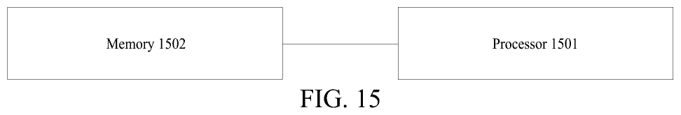

Embodiments of the present disclosure further provide a touch positioning device, as shown in FIG. 15, including a processor 1501 and a memory 1502 storing a computer program that can be executed on the processor, wherein the processor 1501 implements the touch positioning method as described in any of previous embodiments when executing the program.

The touch positioning device can realize the touch positioning method as described in any of previous embodiments. Therefore, the touch positioning device also has the technical effect which the touch positioning method has as described in any of previous embodiments.

Embodiments of the present disclosure further provide a touch apparatus, the touch apparatus including:
sensors, reference may be made to FIGS. 1 and 2; a quantity of the sensors may be one or more; a plurality of sensors can be arranged symmetrically or asymmetrically;
the touch positioning device as described in preceding embodiments, configured to receive touch signals collected by the sensors;

The touch apparatus can be a touch mobile phone, a touch computer or other types of touch electronic products.

The touch apparatus has the touch positioning device as described in preceding embodiments, and therefore, the touch apparatus also has the technical effect which the touch positioning device has as described in the preceding embodiments.

It may be understood by those of ordinary skills in the art that all or some steps in the above method, and function modules/units in the system and the apparatus in the disclosure may be implemented as software, firmware, hardware, or an appropriate combination thereof. In a hardware implementation, division of the function modules/units mentioned in the above description is not always corresponding to division of physical assemblies. For example, a physical assembly may have multiple functions, or a function or an step may be executed by several physical assemblies in cooperation. Some assemblies or all assemblies may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, computer-readable instructions, a data structure, a program module, or other data). The computer storage medium includes, but is not limited to, RAM, ROM, EEPROM, a Flash RAM, or another memory technology, CD-ROM, a Digital Versatile Disk (DVD) or another optical disk storage, a magnetic box, a magnetic tape, magnetic disk storage or another magnetic storage apparatus, or any other medium that may be used for storing desired information and may be accessed by a computer. In addition, it is known to those of ordinary skills in the art that the communication medium usually includes computer-readable instructions, a data structure, a program module, or other data in a modulated data signal of, such as, a carrier or another transmission mechanism, and may include any information delivery medium.

1. A touch positioning method, the method comprising:
acquiring touch signals collected by sensors disposed on a touch apparatus and generated after the touch apparatus is touched;
determining a positioning region according to the touch signals collected by the sensors, and determining a touch position according to calibration signals of the sensors corresponding to a preset position point in the positioning region; and
controlling the touch apparatus to execute a corresponding function based on the touch position.

2. The method according to claim 1, wherein,
the determining the positioning region based on the touch signals collected by the sensors, and determining the touch position based on the calibration signals of the sensors corresponding to the preset position point in the positioning region comprises:
screening out the touch signals, and determining a signal distribution region of a sensor corresponding to a screened out touch signal;
determining an initial positioning region of the touch position based on the touch signals collected by the sensors and calibration signals of sensors corresponding to preset first-category position points in the signal distribution region; and
continuing to determine the touch position based on the touch signals collected by the sensors and calibration signals of sensor corresponding to preset second-category position points in the initial positioning region.

3. The method according to claim 2, wherein,
determining the initial positioning region of the touch position based on the touch signals collected by the sensors and the calibration signals of the sensors corresponding to the first-category position points in the signal distribution region comprises:
comparing distance values between the touch signals collected by the sensors and calibration signals of sensors corresponding to all or part of the first-category position points; taking a first-category position point with a distance value meeting a preset requirement as an initial position point; and
determining the initial positioning region based on the initial position point.

4. The method according to claim 3, wherein,
the comparing the distance values between the touch signals collected by the sensors and the calibration signals of the sensors corresponding to all or part of the first-category position points, and taking the first position point with the distance value meeting the preset requirement as the initial position point comprises:
composing the touch signals collected by the sensors into a real-time signal vector;
composing the calibration signals of the sensors corresponding to all or part of the first-category position points respectively into a position signal vector;
comparing a distance between the real-time signal vector and all or part of position signal vectors formed, respectively; and
taking a first-category position point corresponding to a distance meeting a preset requirement as the initial position point.

5. The method according to claim 3, wherein,
the determining the initial positioning region based on the initial position point comprises:
taking a region with a specified shape containing the initial position point as the initial positioning region;
wherein the initial position point is a specified point of the region with the specified shape.

6. The method according to claim 2, wherein,
the continuing to determine the touch position based on the touch signals collected by the sensors and the calibration signals of the sensors corresponding to the second-category position points in the initial positioning region comprises:
comparing the touch signals collected by the sensors with calibration signals of sensors corresponding all or part of the second-category position points respectively, to obtain first distance values;
comparing a first signal with all or part of second signals respectively, to obtain second distance values, wherein the first signal is configured to characterize a magnitude relationship between the touch signals collected by the plurality of sensors; a second signal is configured to characterize a magnitude relationship between the calibration signals of the sensors corresponding to the second-category position points;
for all or part of the second-category position points, determining a composite index value based on a first distance value and a second distance value corresponding to each of the second-category position points; and
determining the touch position based on composite index values corresponding to all or part of the second-category position points.

7. The method according to claim 6, wherein,
a method for acquiring the first signal comprises:
pairwise comparing the touch signals collected by the sensors, and forming each comparison result into the first signal;
and/or,
a method for acquiring the second signal comprises:
pairwise comparing the calibration signals of the sensors corresponding to all or part of the second-category position points, and forming each comparison result into the second signal;
wherein,
assigning the comparison result as a first value when the comparison result is “greater than”;
assigning the comparison result as a second value when the comparison result is “less than”;
assigning the comparison result as a third value when the comparison result is “equal”;
wherein the first value, the second value, and the third value are all different from each other.

8. The method according to claim 6, wherein,
for all or part of the second-category position points, determining the composite index value based on the first distance value and the second distance value corresponding to each of the second-category position points comprises:
taking a product of the first distance value and the second distance value corresponding to each second-category position point of all or part of the second-category position points as a composite index value for the second-category position point;
the determining the touch position based on the composite index values corresponding to all or part of the second-category position points comprises:
establishing a mapping relationship model between a second-category position point in the initial positioning region and the composite index value for the second-category position point based on the composite index values corresponding to all or part of the second-category position points; and
determining a quantity of minimum values for a composite index based on the mapping relationship model, and determining the touch position based on the quantity.

9. The method according to claim 8, wherein,
the determining the touch position based on the quantity comprises:
when the quantity of the minimum values is only one, determining a plurality of second-category position points based on the mapping relationship model, distances between the plurality of second-category position points and a second-category position point directly corresponding to the minimum value meet a preset distance requirement, and composite index values corresponding to the plurality of second-category position points meet a preset composite index requirement;
calculating a center position of a region form by the plurality of second-category position points, and determining the center position as the touch position;
or,
when the quantity of the minimum values is not only one, for all or part of the minimum values, determining a plurality of second-category position points corresponding to each of the minimum values based on the mapping relationship model, wherein distances between the plurality of second-category position points and a second-category position point directly corresponding to the minimum value meet the preset distance requirement, and composite index values corresponding to the plurality of second-category position points meet the preset composite index requirement;
determining a size of a region form by the plurality of second-category position points and a magnitude of a composite index of the region; and
determining the touch position based on a size of a region determined by all or part of the minimum values and a magnitude of a composite index of the determined region.

10. The method according to claim 9, wherein,
determining the magnitude of the composite index of the region comprises:
calculating an average value of weights of composite indexes corresponding to second-category position points in the region;
the determining the touch position based on the size of the region determined by all or part of the minimum values and the magnitude of the composite index of the determined region comprises:
calculating a product of an area of all or part of the determined region and an average value of weighs of composite indexes of the region, or calculating a sum of the area of all or part of the determined region and the average value of the weighs of the composite indexes of the region; and
determining a center position of a region corresponding to a calculation result meeting a preset requirement as the touch position.

11. The method according to claim 2, wherein:
a quantity of the sensors is multiple, and the touch signals collected by the sensors is a multi-channel touch signal;
a method for acquiring the multi-channel touch signal comprises:
acquiring a multi-channel original touch signal, and different channels of original touch signals come from different sensors;
when it is judged that large signals and small signals exist in the multi-channel original touch signal, and a quantity of the small signals is greater than a preset signal quantity, performing processing on the multi-channel original touch signal which comprises: at least performing signal enhancement on the small signals; a large signal refers to a signal with a signal-to-noise ratio greater than a preset signal-to-noise ratio threshold, and a small signal refers to a signal with a signal-to-noise ratio less than the preset signal-to-noise ratio threshold;
taking a processed multi-channel original touch signal as the multi-channel touch signal.

12. The method according to claim 11, wherein,
a method for performing the signal enhancement comprises:
first performing a grayscale expansion processing on the signal by a preset first structural element K1*N, and then performing a grayscale closure operation on the signal after the grayscale expansion processing by a preset second structural element K2*N, where K1 and K2 are preset values, and N is equal to a quantity of the plurality of sensors or a quantity of the small signals.

13. The method according to claim 11, wherein,
the acquiring the multi-channel original touch signal comprises:
performing consistency measurement on a current sampling frame and an adjacent sampling frame of the multi-channel original touch signal, and when it is judged that two frames participating in the consistency measurement meet a consistency requirement, taking the current sampling frame as a starting signal of the multi-channel original touch signal; wherein, the current sampling frame and its adjacent sampling frame are both M-dimensional data frames, and M is equal to the quantity of the plurality of sensors.

14. The method according to claim 11, wherein,
the performing the processing on the multi-channel original touch signal further comprises one or more of the following:
before at least performing the signal enhancement on the small signals, performing interpolation processing on an acquired multi-channel original touch signal in the time domain;
after at least performing the signal enhancement on the small signals, performing a scaling operation on the acquired multi-channel original touch signal, such that a scaled multi-channel original touch signal is within a preset signal range; and
after at least performing the signal enhancement on the small signals, performing consistency measurement on a sampling frame and its adjacent frame of the multi-channel original touch signal sequentially, and when judging that two frames participating in the consistency measurement meet a consistency requirement, the sampling frame is taken as a valid frame; and combining original touch signals of all valid frames.

15. The method according to claim 14, wherein,
the performing the acquired multi-channel original touch signal comprises:
when the original touch signal is a small-amplitude signal, performing a scaling-up operation on the original touch signal by an exponential operation;
when the original touch signal is a large-amplitude signal, performing a scaling-down operation on the original touch signal by a logarithmic operation;
the small-amplitude signal refers to a signal with an amplitude whose absolute value is less than a preset amplitude threshold; the large-amplitude signal refers to a signal with an amplitude whose absolute value is greater than the preset amplitude threshold;
or,
performing a scaling-up operation on the original touch signal when an absolute value of an amplitude of the original touch signal is located in a first preset interval;
keeping the original touch signal unchanged when the absolute value of the amplitude of the original touch signal is located in a second preset interval;
performing a scaling-down operation on the original touch signal when the absolute value of the amplitude of the original touch signal is located in a third preset interval;
wherein values of the first preset interval, the second preset interval, and the third preset interval gradually increase.

16. The method according to claim 13, wherein,
the judging that the two frames participating in the consistency measurement meet the consistency requirement comprises:
performing a dot product operation on the two frames participating in the consistency measurement;
judging whether a result of the dot product operation meets a preset consistency requirement, and when the result of the dot product operation meets the preset consistency requirement, it is determined that the two frames participating in the consistency measurement meet the consistency requirement.

17. The method according to claim 13, wherein,
the judging that the two frames participating in the consistency measurement meet the consistency requirement comprises:
dimensionality-reducing one of the frames participating in the consistency measurement from an M-dimensional vector to a K-dimensional vector by a preset first projection matrix, where 1≤K≤M, and M is equal to a quantity of the plurality of sensors;
dimensionality-reducing the other frame participating in the consistency measurement from an M-dimensional vector to a K-dimensional vector by a preset second projection matrix;
performing a dot product operation on the two frames after dimensionality reduction;
judging whether a result of the dot product operation meets a preset consistency requirement, and when the result of the dot product operation meets the preset consistency requirement, it is determined that the two frames participating in the consistency measurement meet the consistency requirement; and
a difference value between the first projection matrix and the second projection matrix meets a difference requirement; or, a ratio between the first projection matrix and the second projection matrix is proportional to a force ratio, and the force ratio refers to a ratio of a force value determined based on the one of the frames to a force value determined based on the other frame.

18. A non-transient computer-readable storage medium, storing program instructions capable of implementing the touch positioning method according to claim 1 when the program instructions are executed.

19. A touch positioning device comprising a processor and a memory storing a computer program runnable on the processor, wherein the processor implements the touch positioning method according to claim 1 when executing the program.

20. A touch apparatus, comprising:
sensors; and
the touch positioning device according to claim 19 configured to receive touch signals collected by the sensors.
